(19) United States
(12) Patent Application Publication
(10) Pub. No.: US 2018/0354436 A1
(43) Pub. Date: Dec. 13, 2018

(54) SWITCH DEVICE FOR IN-VEHICLE POWER SUPPLY, AND IN-VEHICLE POWER SUPPLY DEVICE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Shinichiro Sato, Yokkaichi, Mie (JP)

(73) Assignees: AutoNetworks Technologies, Ltd., Yokkaichi, Mie (JP); SUMITOMO ELECTRIC INDUSTRIES, LTD., Osaka-shi, Osaka (JP); Sumitomo Wiring Systems, Ltd., Yokkaichi, Mie (JP); SUMITOMO ELECTRIC INDUSTRIES, LTD., Osaka-shi, Osaka (JP)

(21) Appl. No.: 15/780,663

(22) PCT Filed: Jan. 31, 2017
(86) PCT No.: PCT/JP2017/003305

§ 371 Date: Jun. 1, 2018

(30) Foreign Application Priority Data
Feb. 17, 2016 (JP) 2016-027719

(51) Int. Cl. B60R 16/033; H02J 7/00; H02H 3/16

(52) U.S. Cl. CPC B60R 16/033; H02J 7/0031; H02J 2007/0059; H02H 3/16; H02J 7/0054

(57) ABSTRACT

An in-vehicle power supply switch device that is suited to charging is provided. A first switch is connected between a first load and a first power storage device. A second switch is connected between the first load and a second power storage device. A third switch is connected in parallel to a set of the first switch and the second switch, and has a smaller resistance value than both the resistance value of the first switch and the resistance value of the second switch.

### CROSS-REFERENCE TO RELATED APPLICATIONS

This application is the U.S. national stage of PCT/JP2017/003305 filed Jan. 31, 2017, which claims priority of Japanese Patent Application No. 2016-027719 filed on Feb. 17, 2016, which is incorporated herein by reference in its entirety.

### FIELD OF THE INVENTION

This description relates to an in-vehicle power supply switch device and an in-vehicle power supply device.

### BACKGROUND OF THE INVENTION

An in-vehicle power supply device is disclosed in JP 2015-83404A. This in-vehicle power supply device includes a main battery, a sub battery, first to third switches, and a group of auxiliary devices. The first switch is connected between the main battery and the group of auxiliary devices, and the second switch and third switch are connected to each other in series between the sub battery and the group of auxiliary devices.

In this in-vehicle power supply device, when an abnormality occurs on the main battery side, the main battery can be cut off from the group of auxiliary devices by turning off the first switch. Also, by turning on the second and third switches at this time, power can be supplied to the group of auxiliary devices from the sub battery. On the other hand, if an abnormality occurs on the sub battery side, the sub battery can be cut off from the group of auxiliary devices by turning off the second and third switches. Also, by turning on the first switch at this time, power can be supplied to the group of auxiliary devices from the main battery.

As described above, in: JP 2015-83404A, when an abnormality occurs on either one of the main battery side and the sub battery side, power is supplied to the group of auxiliary devices from the other one. In other words, the group of auxiliary devices is provided with a redundant power supply. Note that JP 2013-252017A and JP 2015-9792A also show examples of technology related to the present description.

### SUMMARY OF THE INVENTION

However, in JP 2015-83404A, the sub battery is charged via multiple switches that are connected in series. When the sub battery is charged via multiple switches in this way, the sub battery is charged via a high resistance value. Accordingly, power consumption increases, or a longer period of time is required for charging, for example. In other words, it is hard to say that the configuration in JP 2015-83404A is suited to the charging of the sub battery.

In view of this, an object of the present description is to provide an in-vehicle power supply switch device that is suited to charging.

A first aspect of an in-vehicle power supply switch device includes: a first switch that is connected between a first load and a first power storage device; a second switch that is connected between the first load and a second power storage device; and a third switch that is connected in parallel to a set of the first switch and the second switch, and has a smaller resistance value than a resistance value of the first switch and a resistance value of the second switch.

A second aspect of the in-vehicle power supply switch device is the in-vehicle power supply switch device according to the first aspect, further including a control circuit that controls on and off states of the first switch, the second switch, and the third switch, wherein upon detecting that a ground fault occurred on a first power storage device side of the first switch or the third switch, the control circuit turns off the third switch before turning off the first switch.

A third aspect of the in-vehicle power supply switch device is the in-vehicle power supply switch device according to the first aspect, further including a control circuit that controls on and off states of the first switch, the second switch, and the third switch, wherein upon detecting that a ground fault occurred on a second power storage device side of the second switch or the third switch, the control circuit turns off the third switch before turning off the second switch.

A fourth aspect of the in-vehicle power supply switch device is the in-vehicle power supply switch device according to the first aspect, further including a control circuit that controls on and off states of the first switch, the second switch, and the third switch, wherein the first power storage device is a lead battery, and upon detecting that a ground fault occurred on a first load side of the first switch, the control circuit turns off the first switch before turning off the second switch.

A fifth aspect of the in-vehicle power supply switch device is the in-vehicle power supply switch device according to the first aspect, further including a control circuit that controls on and off states of the first switch, the second switch, and the third switch, wherein one end of the second switch, the one end being on a second power storage device side, is connected to the second power storage device via a switch or a battery unit that is a bidirectional DC/DC converter, and when the control circuit detects that a ground fault occurred on a second power storage device side of the battery unit in a state where the second switch and the third switch are on or a state where the first switch is on, the battery unit turns off.

An in-vehicle power supply device includes the in-vehicle power supply switch device according to any one of the first to fifth aspects, and a first power storage device and a second power storage device.

The first aspect of the in-vehicle power supply switch device and the in-vehicle power supply device are suited to charging of the first power storage device and the second power storage device.

According to the second and third aspects of the in-vehicle power supply switch device, it is possible to lower the ground fault current.

According to the fourth aspect of the in-vehicle power supply switch device, it is possible to retain the amount of power stored in the lead battery.

According to the fifth aspect of the in-vehicle power supply switch device, it is possible to handle a ground fault with a small number of times that switches are switched.

### BRIEF DESCRIPTION OF THE DRAWINGS

FIG. 1 is a diagram schematically showing an example of an in-vehicle power supply system.

FIG. 2 is a flowchart showing an example of operations of a control circuit.

FIG. 3 is a diagram schematically showing an example of ground faults.

FIG. 4 is a diagram schematically showing an example of the in-vehicle power supply system at the time when ground faults occur.

FIG. 5 is a diagram schematically showing an example of timing charts.

FIG. 6 is a diagram schematically showing an example of timing charts.

FIG. 7 is a diagram schematically showing an example of timing charts.

FIG. 8 is a diagram schematically showing an example of timing charts.

FIG. 9 is a diagram schematically showing an example of timing charts.

FIG. 10 is a diagram schematically showing an example of a timing chart.

FIG. 11 is a diagram schematically showing an example of the in-vehicle power supply system at the time when ground faults occur.

FIG. 12 is a diagram schematically showing an example of timing charts.

FIG. 13 is a diagram schematically showing an example of timing charts.

FIG. 14 is a diagram schematically showing an example of timing charts.

FIG. 15 is a diagram schematically showing an example of timing charts.

FIG. 16 is a diagram schematically showing an example of an in-vehicle power supply system.

FIG. 17 is a diagram schematically showing an example of an in-vehicle power supply system.

FIG. 18 is a diagram schematically showing an example of an in-vehicle power supply system.

FIG. 19 is a diagram schematically showing another example of an in-vehicle power supply system.

### DETAILED DESCRIPTION OF THE PREFERRED EMBODIMENTS

Configuration

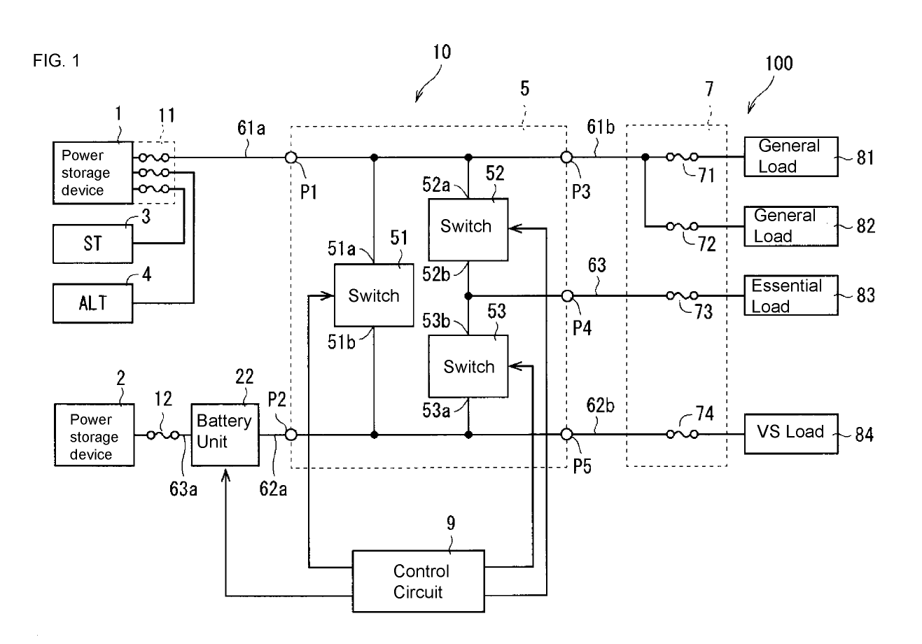

FIG. 1 is a diagram schematically showing an example of the configuration of an in-vehicle power supply system 100. The in-vehicle power supply system 100 is for installation in a vehicle. This in-vehicle power supply system 100 includes at least an in-vehicle power supply device 10 and loads 81 to 84. As illustrated in FIG. 1, the in-vehicle power supply system 100 may further include a battery unit 22, a starter 3, a generator 4, a fuse box 7, a group of fuses 11, and a fuse 12. The group of fuses 11 is realized by a battery fuse terminal (BTF), for example.

The in-vehicle power supply device 10 includes power storage devices 1 and 2 and a switch device 5. The switch device 5 is an in-vehicle power supply switch device, with the power storage devices 1 and 2 provided at the input side thereof, and the loads 81 to 84 provided at the output side thereof. This switch device 5 is a device that switches the electrical connection relationship between power storage devices 1 and 2 and the loads 81 to 84, and includes switches 51 to 53. The on and off states of the switches 51 to 53 are controlled by a control circuit 9.

The switches 51 to 53 are each constituted by a relay for example, and the opening and closing of the relays corresponds to the turning on and off of the switches 51 to 53. In the case where the switches 51 to 53 are constituted by a relay in this way, the switch device 5 can be perceived to be a relay module.

Here, first, the connection relationship between the switches 51 to 53, the power storage devices 1 and 2, and the load 83 will be described. The switch 52 is connected between the power storage device 1 and the load 83, and the switch 53 is connected between the power storage device 2 and the load 83. Also, the switches 52 and 53 are connected to each other in series between the power storage devices 1 and 2. The switch 51 is connected in parallel to the set of switches 52 and 53.

In the illustration of FIG. 1, the switch device 5 includes connection points P1 to P5. The connection points P1 to P5 and the switches 51 to 53 may be provided on a predetermined substrate, for example. The connection point P1 is connected to the power storage device 1 via a power supply line 61a and a first fuse in the group of fuses 11. The power supply line 61a is an electrical wire for example, and is included in a wire harness. The same follows for power supply lines 62a, 63a, 61b, 62b, and 63 that will be described later. Also, one end 52a of the switch 52 and one end 51a of the switch 51 are connected to the connection point P1. The one end 52a of the switch 52 and the one end 51a of the switch 51 are connected to the connection point P1 via a wiring pattern that is formed in a predetermined substrate, for example.

The connection point P2 is connected to the power storage device 2 via the power supply line 62a, the battery unit 22, a power supply line 63a, and a fuse 12 in this order. The battery unit 22 is a relay or a bidirectional DC/DC converter for example, and can control electrical connection and disconnection between the power supply lines 62a and 63a. If the battery unit 22 is a bidirectional DC/DC converter, the battery unit 22 performs voltage conversion between the voltage on the power supply line 62a and the voltage on the power supply line 63a. For example, when the power storage device 2 is being charged, the voltage on the power supply line 62a side is converted to a desired voltage and output to the power supply line 63a, and when the power storage device 2 is discharging power, the voltage on the power supply line 63a side is converted to a desired voltage and output to the power supply line 62a. Operation of the battery unit 22 is controlled by the control circuit 9, for example. Also, the connection point P2 is connected to one end 53a of the switch 53 and another end 51b of the switch 51 via a wiring pattern, for example.

The connection point P4 is connected to the load 83 via a power supply line 63 and a fuse 73. Note that multiple loads may be connected to the connection point P4. In this case, multiple fuses may be provided in correspondence with these loads. Also, the connection point P4 is connected to another end 52b of the switch 52 and another end 53b of the switch 53 via a wiring pattern, for example.

In this configuration, the switch 52 is connected between the power storage device 1 and the load 83, the switch 53 is connected between the power storage device 2 and the load 83, and the switch 51 is connected in parallel to the set of the switches 52 and 53.

The connection point P3 is connected to the load 81 via a power supply line 61b and a fuse 71, and is connected to the load 82 via the power supply line 61b and a fuse 72. Note that the number of loads that are connected to the connection point P3 is not limited to two, and may be one or more. Also, the connection point P3 is connected to the one end 52a of the switch 52 and the one end 51a of the switch 51 via a wiring pattern, for example.

The connection point P5 is connected to the load 84 via a power supply line 62b and a fuse 74. Note that multiple loads may be connected to the connection point P5. In this case, multiple fuses may be provided in correspondence with these loads. Also, the connection point P5 is connected to the one end 53a of the switch 53 and the other end 51b of the switch 51 via a wiring pattern, for example. The fuses 71 to 74 may be housed inside the fuse box 7. Note that the connection points P1 to P5 may be connectors for connection to the power supply lines 61a, 62a, 61b, 63, and 62b respectively.

The power storage device 1 is a lead battery, for example. In the illustration of FIG. 1, the starter 3 is connected to the power storage device 1 via a second fuse in the group of fuses 11. The starter 3 has a motor for starting up the engine, and is denoted by “ST” in FIG. 1.

The generator 4 is an alternator for example, and generates power and outputs a DC voltage as the engine of the vehicle rotates. In the illustration of FIG. 1, the generator 4 is denoted by “ALT”. The generator 4 may be an SSG (Side mounted Starter Generator). This generator 4 is connected to the power storage device 1 via a third fuse in the group of fuses 11. The generator 4 can charge the power storage devices 1 and 2. The power storage device 2 is a lithium ion battery, a nickel hydrogen battery, or a capacitor, for example.

In the illustration of FIG. 1, the loads 81 and 82 are denoted by “general load”, the load 83 is denoted by “essential load”, and the load 84 is denoted by “VS load”. This will be described below. The load 83 receives power from the power storage devices 1 and 2 via the switches 52 and 53 respectively. Accordingly, when an abnormality occurs on the power storage device 1 side, even if the switch 52 is turned off so as to cut off the power storage device 1 from the load 83, the load 83 can receive power from the power storage device 2 via the switch 53. The same follows for when an abnormality occurs on the power storage device 2 side as well. In other words, the load 83 connected to the connection point P4 is provided with a redundant power supply. Accordingly, an essential load, for which the maintenance of power supply is prioritized, may be adopted as the load 83. For example, a load related to vehicle travel control, a load related to autonomous driving (e.g., a control circuit such as a microcontroller), or a load related to driver safety can be applied as the essential load.

The loads 81 and 82 are connected to the power storage device 1 without intervention of the switches 51 to 53, for example. Accordingly, when the abnormality on the power storage device 1 side is a ground fault that occurs on the power supply line 61a for example, power cannot be appropriately supplied to the loads 81 and 82. Accordingly, a general load, for which a cutoff of power supply is tolerable, may be applied as the loads 81 and 82. For example, a compartment lamp that illuminates the interior of the vehicle can be applied as the general load.

In the illustration of FIG. 1, the load 84 is connected to the power storage device 2 via the battery unit 22 and without intervention of the switches 51 to 53. If the battery unit 22 is a DC/DC converter, the battery unit 22 can convert a voltage from the power storage device 2 into a desired voltage and output it to the load 84. Accordingly, the battery unit 22 can apply a more stable voltage to the load 84 than in the case where a relay is used. Accordingly, a VS (Voltage-stabilized) load, which does not require the maintenance of power supply in comparison to an essential load, but requires a more stable voltage than a general load, may be applied as the load 84. The stable voltage referred to here is a voltage that is not likely to fall below the minimum operable value of the load, that is to say a voltage that is not likely to cause a momentary stop for example. For example, a control circuit (e.g., a microcontroller) that controls a load installed in the vehicle can be applied as the VS load.

In this in-vehicle power supply system 100, the switch 51 has a smaller resistance value than the resistance value of the switches 52 and 53. For example, the resistance values of the switches 52 and 53 are several (e.g., 2 to 3) [mΩ], and the resistance value of the switch 51 is several hundred (e.g., around 100) [μΩ]. This switch 51 has a larger size than the switches 52 and 53. For example, the switch 51 has a size of several hundred (e.g., around 200) [mm]×several hundred (e.g., around 300) [mm] in a plan view, whereas the switches 52 and 53 have a size of several tens of (e.g., around 20) [mm]×several tens of (e.g., around 20) [mm] in a plan view. Also, the price of the switch 51 is higher than the price of the switches 52 and 53. For example, the price of the switch 51 is approximately 100 times the price of the switches 52 and 53.

The control circuit 9 controls the switches 51 to 53 and the battery unit 22. The control circuit 9 may be an ECU (Electrical Control Unit) for example, or may be a BCM (Body Control Module) that performs overall control of the vehicle.

Also, here, the configuration of the control circuit 9 includes a microcomputer and a storage device. The microcomputer executes processing steps that are described in a program (in other words, a procedure). The storage device can be constituted by one or more storage devices such as a ROM (Read Only Memory), a RAM (Random Access Memory), a rewritable non-volatile memory (e.g., an EPROM (Erasable Programmable ROM)), or a hard disk device. This storage device stores various types of information, data, and the like, stores programs that are to be executed by the microcomputer, and provides a work area for program execution. Note that the microcomputer can be understood as functioning as various means that correspond to processing steps described in a program, or can be understood as realizing various functions that correspond to such processing steps. Also, the control circuit 9 is not limited to this description, and some or all of the various procedures executed by the control circuit 9, or some or all of the various means or functions realized by the control circuit 9 may be realized by hardware circuits. The same follows for other control circuits that will be described later.

Control

The control circuit 9 controls the switches 51 to 53 and the battery unit 22 in accordance with the traveling state of the vehicle, for example. The following table shows an example of switch patterns that are employed during vehicle traveling.

TABLE 1

| Control Pattern | Switch 51 | Switch 52 | Switch 53 | Battery Unit 22 |
|---|---|---|---|---|
| A | ON | ON | ON | ON |
| B | OFF | OFF | ON | ON |
| C | ON | OFF | ON | ON |

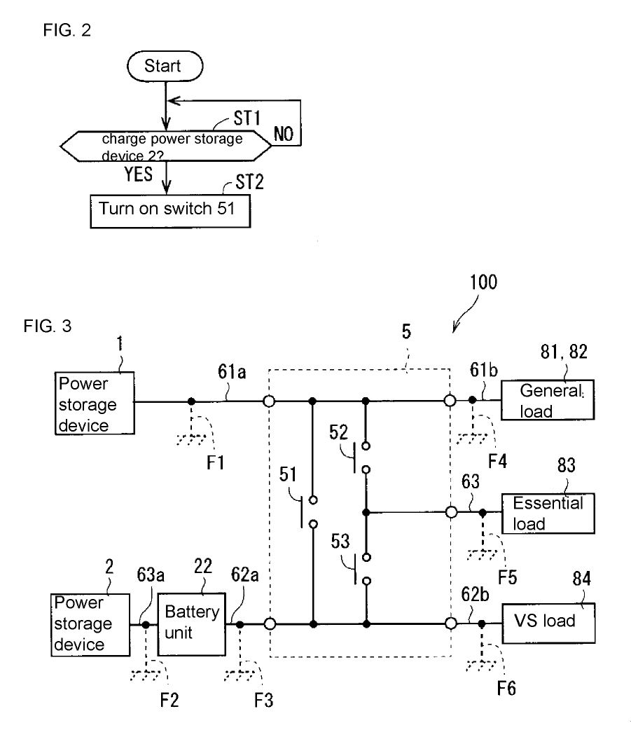

For example, when charging the power storage device 2, the control circuit 9 employs either one of control patterns A and C. In other words, the control circuit 9 turns on the switch 51 when charging the power storage device 2. FIG. 2 is a flowchart showing an example of operations of the control circuit 9. First, in step ST1, the control circuit 9 determines whether or not the power storage device 2 is to be charged. For example, it may be determined that the power storage device 2 is to be charged when vehicle deceleration is detected. A configuration is possible in which a detector that detects the accelerator position is provided, and whether or not the vehicle is decelerating is determined based on the accelerator position, for example. If it is determined that the power storage device 2 is not to be charged, the control circuit 9 executes step ST1 again. If it is determined that the power storage device 2 is to be charged, in step ST2, the control circuit 9 turns on the switch 51.

Accordingly, the power storage device 2 can be charged via the switch 51 that has a smaller resistance value than the resistance value of the switches 52 and 53. For the following reason, this is preferable over the case where the power storage device 2 is charged via only the switches 52 and 53, that is to say via a large resistance. Specifically, if the power storage device 2 is charged by a constant current (I) for example, the resistance (R) is small, and therefore the loss generated by the switch (=R·I²) is small. Also, if the power storage device 2 is charged by a constant voltage for example, the resistance is small, and therefore the charging current can be increased. The charging time can therefore be shortened.

Note that in contrast to the present embodiment, the above-described effect is achieved even if the switch 51 is omitted and the resistance values of the switches 52 and 53 are lowered. For example, a low-resistance switch having a resistance value that is approximately half the resistance value of the switch 51 may be employed as the switches 52 and 53. However, as described above, such a low-resistance switch has a large size, and if low-resistance switches are employed as the two switches 52 and 53, the size of the switch device 5 increases. Also, as described above, such a low-resistance switch is expensive, and if low-resistance switches are employed as the two switches 52 and 53, the price of the switch device 5 increases.

In contrast, in the present embodiment, the switch 51 having a small resistance value is provided in parallel with the switches 52 and 53. Accordingly, the size and cost of the switch device 5 can be lower than in the case where low-resistance switches are employed as the two switches 52 and 53.

Ground Fault

A ground fault can occur on the power supply lines 61a to 63a, 61b, 62b, and 63. FIG. 3 is a diagram schematically showing an example of ground faults F1 to F6 that occur on the power supply lines 61a, 63a, 62a, 61b, 63, and 62b respectively. In the illustration of FIG. 3, the ground faults F1 to F6 are indicated by the graphic symbol for ground. Also, in the illustration of FIG. 3, depictions have been omitted for the starter 3, the generator 4, the fuse box 7, the control circuit 9, the group of fuses 11, and the fuse 12 in order to avoid complexity in the figure. These members have also been omitted as necessary from the other drawings referenced below.

For example, if only the ground fault F1 occurs on the power supply line 61a, a large current flows from the power storage device 1 to the ground fault F1 (hereinafter, also called a ground fault current). In this case, the power storage device 1 cannot appropriately supply power to the loads 81 to 84. Also, at this time, if the switch 52 and the switch 53 are on, or the switch 51 is on, the ground fault current flows from the power storage device 2 to the ground fault F1 via whichever of the switches 51 to 53 are on. In this case as well, the power storage device 2 cannot appropriately supply power to the loads 81 to 84.

If the other ground faults F2 to F6 occur as well, power cannot be appropriately supplied from the power storage device 1 or the power storage device 2. In view of this, if any of the ground faults F1 to F6 occurs, an attempt is made to, whenever possible, maintain the supply of power to the loads 81 to 84 by controlling the switches 51 to 53 in accordance with the location of the ground fault. The ground faults can be detected based on voltage or current. For example, a detector is provided for detecting the voltage applied to the power supply lines 61a and 61b or the current flowing therein, and the ground faults F1 and F4 can be detected based on the detection result. The same follows for the other ground faults as well.

The following table shows an example of switch patterns that are employed when the ground faults F1 to F6 occur.

TABLE 2

| Ground fault | Switch 51 | Switch 52 | Switch 53 | Battery Unit 22 |
|---|---|---|---|---|
| F1, F4 | OFF | OFF | ON | ON |
| F2 | ON | ON | ON | OFF |
| | ON | ON | OFF | OFF |
| | ON | OFF | ON | OFF |
| | OFF | ON | ON | OFF |
| F3, F6 | OFF | ON | OFF | OFF |
| F5 | ON | OFF | OFF | ON |
| | ON | OFF | OFF | OFF |
| | OFF | OFF | OFF | ON |

Ground Faults F1, F4

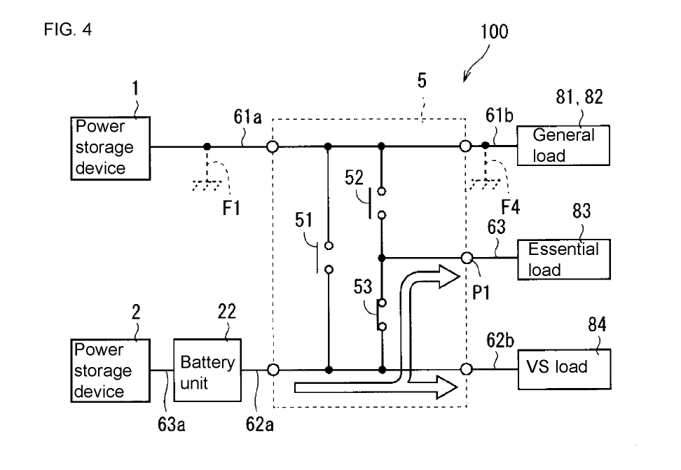

If at least either one of the ground faults F1 and F4 occurs on the power storage device 1 side for example, the control circuit 9 turns off the switches 51 and 52, and turns on the switch 53 and the battery unit 22. FIG. 4 is a diagram schematically showing an example of the in-vehicle power supply system 100 when the ground fault F1 or F4 occurs. As shown in FIG. 4, the switches 51 and 52 are off, and the switch 53 is on. The battery unit 22 is also turned on, and therefore the power storage device 2 can supply power to the loads 83 and 84. In the example of FIG. 4, the paths of this power supply are shown by block arrows.

Note that when at least either one of the ground faults F1 and F4 occurs, power cannot be appropriately supplied to the loads 81 and 82. In other words, when at least either one of the ground faults F1 and F4 occurs, the supply of power to the loads 81 and 82 is abandoned, and power is supplied from the power storage device 2 to the loads 83 and 84.

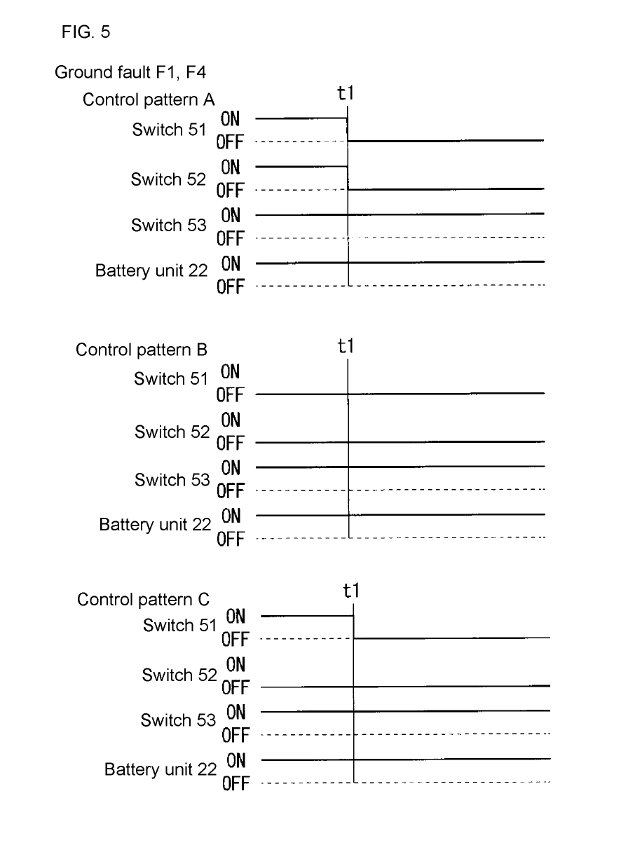

FIG. 5 is a diagram schematically showing an example of timing charts for when at least either one of the ground faults F1 and F4 occurs in the control patterns A to C. In the timing chart at the top of FIG. 5, the control pattern A is employed initially. In other words, initially, the switches 51 to 53 and the battery unit 22 are on. In response to detecting at least either one of the ground faults F1 and F4, the control circuit 9 turns off the switches 51 and 52 at a time t1 that is at or after the time when the ground fault was detected. Accordingly, the switches 51 and 52 are off, and the switch 53 and the battery unit 22 are on.

In the timing chart in the middle of FIG. 5, the control pattern B is employed initially. In other words, initially, the switches 51 and 52 are off, and the switch 53 and the battery unit 22 are on. This switch pattern is the same as the switch pattern that is employed when at least either one of the ground faults F1 and F4 occurs. Accordingly, the control circuit 9 does not change the switch pattern even if at least either one of the ground faults F1 and F4 is detected.

In the timing chart at the bottom of FIG. 5, the control pattern C is employed initially. In other words, initially, the switch 52 is off, and the switches 51 and 53 and the battery unit 22 are on. In response to detecting at least either one of the ground faults F1 and F4, the control circuit 9 turns off the switch 51 and at the time t1.

Control Pattern A

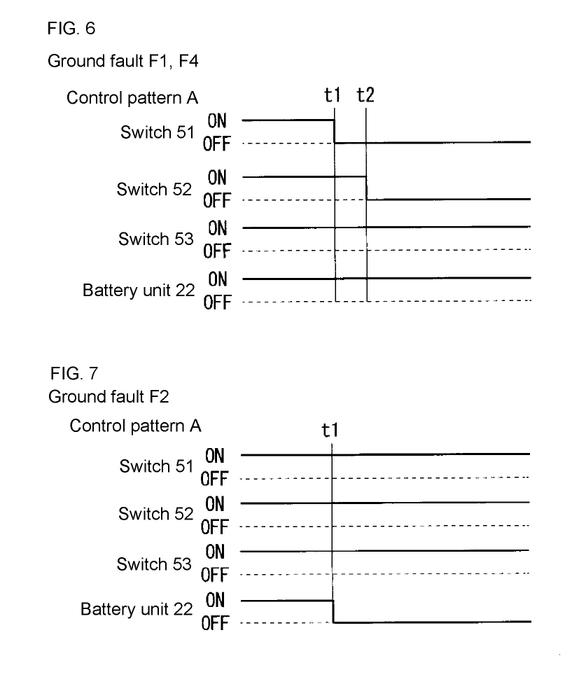

In the control pattern A in FIG. 5, the control circuit 9 switches the two switches 51 and 52. However, there are cases where the control circuit 9 cannot switch the switches 51 and 52 at the same time. In this case, it is desirable that the control circuit 9 turns off the switch 51 before turning off the switch 52. FIG. 6 is a diagram schematically showing an example of timing charts in this case. The control circuit 9 turns off the switch 51 at the time t2, and turns off the switch 52 at a time t2 that is after the time t1. In other words, the control circuit 9 first turns off the switch 51 that has a smaller resistance value, and then turns off the switch 52 that has a larger resistance value.

Accordingly, the total ground fault current that flows from the power storage device 2 to the ground fault F1 or the ground fault F4 can be reduced compared to the case where the switches 51 and 52 are turned off in the opposite order. In other words, more of the ground fault current from the power storage device 2 flows via the switch 51 having a smaller resistance value than via the switch 52, and therefore the ground fault current can be lowered by cutting off the switch 51 first.

Ground Fault F2

When the occurrence of the ground fault F2 on the power supply line 63a is detected, the control circuit 9 turns off the battery unit 22 (see Table 2 as well). Accordingly, the power supply line 63a can be cut off from the switch device 5. Since the power storage device 2 is cut off from the switch device 5 at this time, power cannot be supplied to the loads 81 to 84. In view of this, the control circuit 9 employs any of the four switch patterns that are shown in correspondence with the ground fault F2 in Table 2 in order to supply power from the power storage device 1 to the loads 81 to 84.

It should be noted that the lower the number of times that switches are switched is, the lower the burden on the control circuit 9 is. Accordingly, the control circuit 9 may employ the switch pattern that achieves a lower number of times that switches are switched. For example, in control pattern A, when the ground fault F2 is detected, it is sufficient that the control circuit 9 turns off the battery unit 22 and maintains the switch states of the switches 51 to 53. FIG. 7 is a diagram schematically showing an example of timing charts in this case. In response to detection of the ground fault F2, the control circuit 9 turns off the battery unit 22 at the time t1, and maintains the on state of the switches 51 to 53. Accordingly, when the ground fault F2 occurs, power can be supplied from the power storage device 1 to the loads 81 to 84 via the switches 51 to 53. Moreover, the switches 51 to 53 are not switched between the on and off states before and after detection of the ground fault F2, and therefore the burden on the control circuit 9 is low.

Next, consider the ground fault F2 in the control pattern B. In the control pattern B, if the ground fault F2 occurs, the control circuit 9 needs to appropriately switch not only the operation of the battery unit 22 but also the switch states of the switches 51 to 53. The reason for this is that in the control pattern B, when the battery unit 22 turns off, power cannot be supplied from the power storage device 2 to the loads 83 and 84.

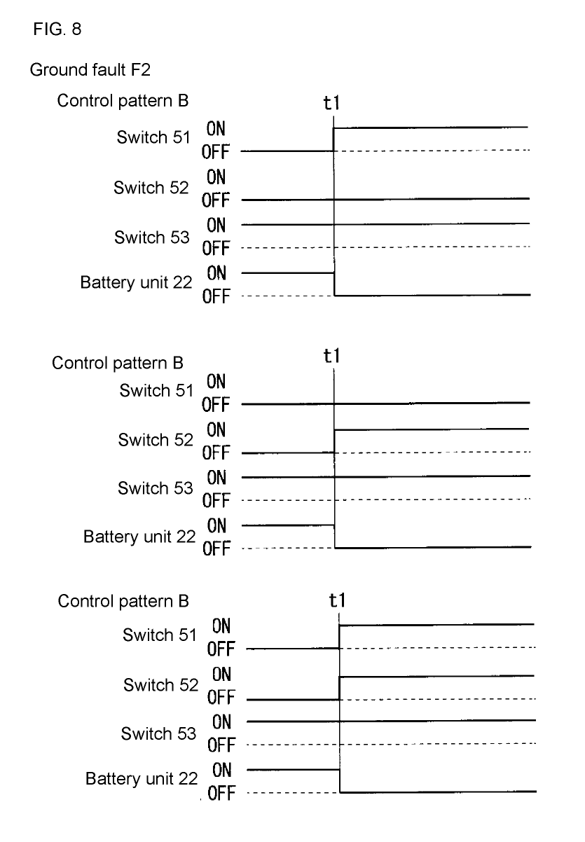

It should be noted that from the viewpoint of reducing the number of times that switches are switched, it is desirable to utilize the on state of the switch 53 in the control pattern B. In other words, it is desirable that the switch 53 does not turn off. FIG. 8 is a diagram schematically showing an example of timing charts in this case. Three timing charts are shown in the illustration of FIG. 8. In the timing chart at the top, in response to detection of the ground fault F2, the control circuit 9 turns on the switch 51 and turns off the battery unit 22 at the time t1. At this time, the power storage device 1 directly supplies power to the loads 81 and 82, supplies power to the load 93 via the switches 51 and 53, and supplies power to the load 84 via the switch 51.

In the timing chart in the middle of FIG. 8, in response to detection of the ground fault F2, the control circuit 9 turns on the switch 52 and turns off the battery unit 22 at the time t1. At this time, the power storage device 1 directly supplies power to the loads 81 and 82, supplies power to the load 83 via the switch 52, and supplies power to the load 84 via the switches 52 and 53.

In the timing chart at the bottom of FIG. 8, the control circuit 9 turns on the switches 51 and 52 and turns off the battery unit 22 at the time t1. At this time, the power storage device 1 directly supplies power to the loads 81 and 82, supplies power to the load 83 via the switch 52, and supplies power to the load 84 via the switches 51 to 53. Note that in view of the number of times that switches are switched, the control at the top and in the middle of FIG. 8 is desirable.

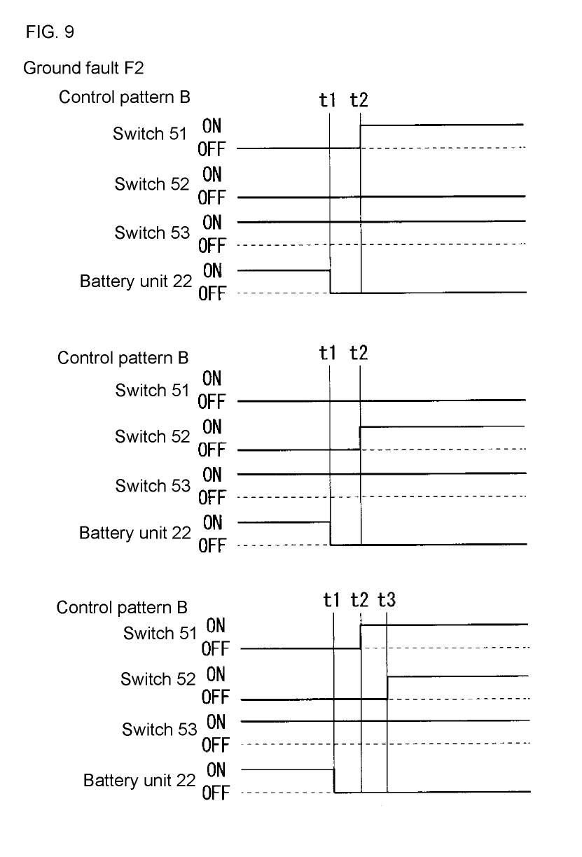

Also, if the control circuit 9 cannot switch the switch states of multiple switches and the operation of the battery unit 22 at the same time, it is desirable that the control circuit 9 switches off the battery unit 22 with the highest priority. This is because this makes it possible to cut off the ground fault current that flows from the power storage device 1 to the ground fault F2. FIG. 9 is a diagram schematically showing an example of timing charts in this case. In the timing chart at the top of FIG. 9, the control circuit 9 turns off the battery unit 22 at the time t1, and turns on the switch 51 at the time t2 thereafter. In the timing chart in the middle of FIG. 9, the control circuit 9 turns off the battery unit 22 at the time t1, and turns on the switch 52 at the time t2 thereafter.

In the timing chart at the bottom of FIG. 9, the control circuit 9 turns off the battery unit 22 at the time t1, turns on the switch 51 at the time t2 thereafter, and turns on the switch 52 at a time t3 thereafter. In this example, the switch 51 is turned on before the switch 52. The reason for this is as follows. The switch 51 has a smaller resistance value than the switch 52, and the current capacity of this switch 51 is larger than that of the switch 52. In other words, even if a large current (power supply current) flows to the load 84, by turning on the switch 51 before the switch 52, power supply current can be appropriately supplied from the power storage device 1 to the load 84 via the switch 51.

Also, by turning on not only the switch 51 but also the switch 52, the power storage device 1 can supply power to the load 83 via the switch 52. Accordingly, power can be supplied to the load 83 with a smaller resistance in the case of flowing through the one switch 52 compared to the case of flowing through the two switches 51 and 53.

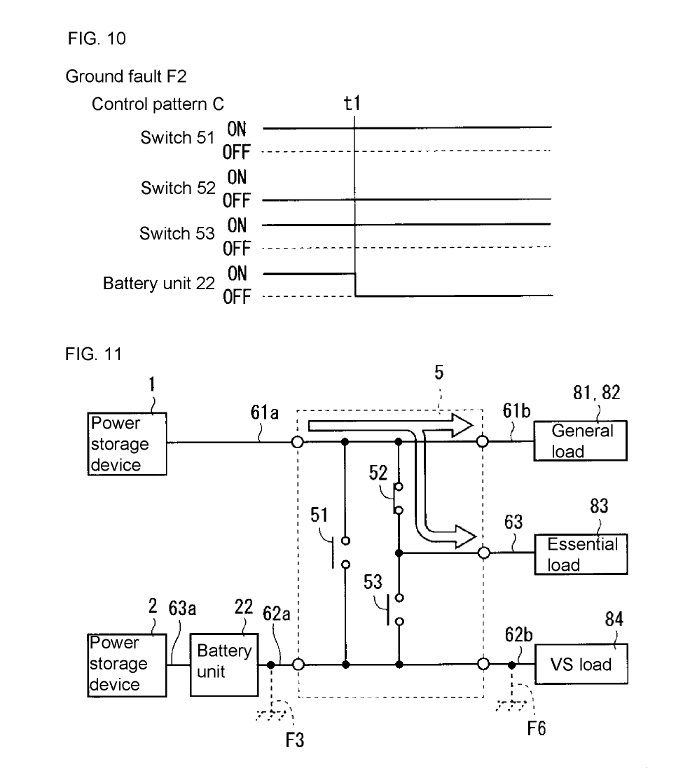

FIG. 10 is a diagram schematically showing an example of a timing chart for when the ground fault F2 occurs in the control pattern C. In the illustration of FIG. 10, in response to detection of the ground fault F2, the control circuit 9 turns off the battery unit 22 at the time t1, and maintains the switch states of the switches 51 to 53. Accordingly, when the ground fault F2 occurs, power can be supplied from the power storage device 1 to the loads 81 to 84. Moreover, in this example, the switches 51 to 53 are not switched between the on and off states before and after detection of the ground fault F2, and therefore the burden on the control circuit 9 is low.

Ground Faults F3, F6

When at least either one of the ground fault F3 and F6 occurs on the power storage device 2 side, the control circuit 9 turns on the switch 52 and turns off the switches 51 and 53 (see Table 2 as well). The battery unit 22 is also turned off. FIG. 11 is a diagram schematically showing an example of the in-vehicle power supply system at the time when either of the ground faults F3 and F6 occurs. As shown in FIG. 11, the switch 52 is on, and the switches 51 and 53 are off, and therefore the power storage device 1 can supply power to the loads 81 to 83. In the illustration of FIG. 11, the paths of this power supply are shown by block arrows.

Note that when at least either one of the ground faults F3 and F6 occurs, power cannot be appropriately supplied to the load 84. In other words, when at least either one of the ground faults F3 and F6 occurs, the supply of power to the load 84 is abandoned, and power is supplied from the power storage device 1 to the loads 81 to 83.

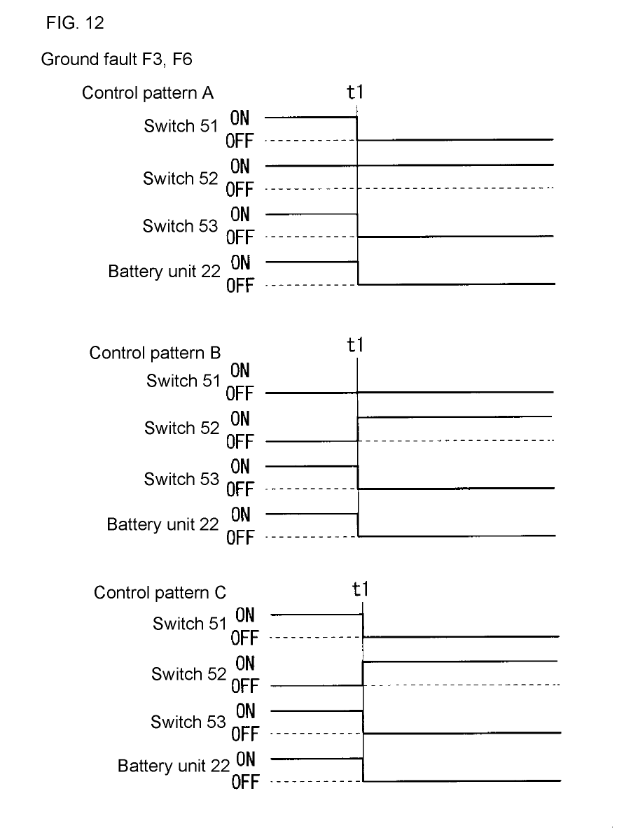

FIG. 12 is a diagram schematically showing an example of timing charts for when at least either one of the ground faults F3 and F6 occurs in the control patterns A to C. In the timing chart at the top of FIG. 12, the control pattern A is employed initially. In response to detecting at least either one of the ground faults F3 and F6, the control circuit 9 turns off the switches 51 and 53 and turns off the battery unit 22 at the time t1.

In the timing chart in the middle of FIG. 12, the control pattern B is employed initially. In response to detecting at least either one of the ground faults F3 and F6, the control circuit 9 turns on the switch 52, turns off the switch 53, and turns off the battery unit 22 at the time t1.

In the timing chart at the bottom of FIG. 12, the control pattern C is employed initially. In response to detecting at least either one of the ground faults F3 and F6, the control circuit 9 turns on the switch 52, turns off the switches 51 and 53, and turns off the battery unit 22 at the time t1.

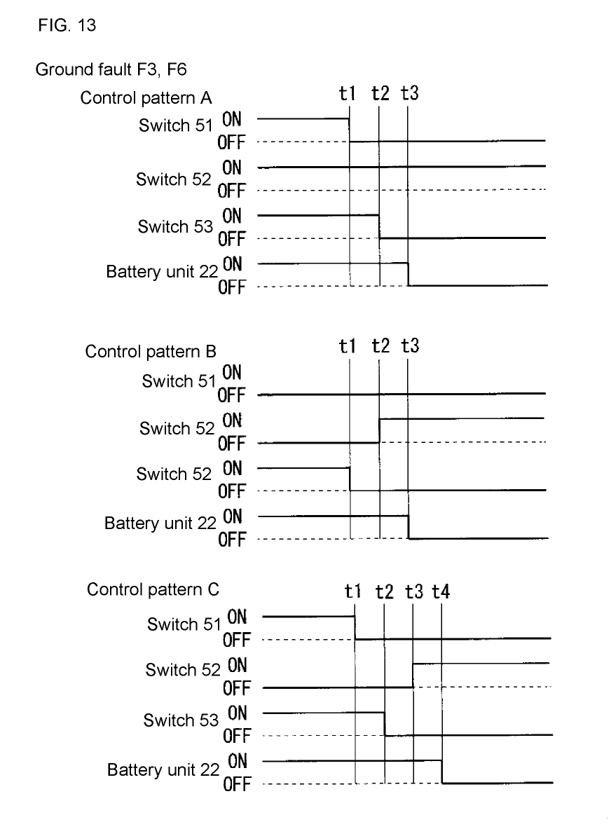

Also, if the control circuit 9 cannot switch the switch states of multiple switches and the operation of the battery unit 22 at the same time, control may be performed as described below. FIG. 13 is a diagram schematically showing an example of timing charts in this case.

In the timing chart at the top of FIG. 13, in the case where the control pattern A is employed initially, in response to detecting at least either one of the ground faults F3 and F6, the control circuit 9 first turns off the switch 51 at the time t1. The control circuit 9 turns off the switch 53 at the time t2 thereafter, and turns off the battery unit 22 at the time t3 thereafter.

As described above, the switch 51 having a smaller resistance value is turned off before the switch 53 having a larger resistance value. Accordingly, the ground fault current that flows from the power storage device 1 to the ground fault F3 or the ground fault F6 via the switch 51 having a smaller resistance value can be cut off with priority in comparison to the opposite case. Also, the turning off of the battery unit 22 does not affect the supply of power from the power storage device 1 to the loads 81 to 83. Accordingly, the turning off of the battery unit 22 has a low priority. Therefore, as described above, the control circuit 9 turns off the battery unit 22 after switching the states of the switches 51 and 53. Note that in the other timing charts of FIG. 13 as well, for similar reasons, the battery unit 22 is appropriately turned off after control of the switches 51 to 53.

In the timing chart in the middle of FIG. 13, in the case where the control pattern B is employed initially, in response to detecting at least either one of the ground faults F3 and F6, the control circuit 9 first turns off the switch 53 at the time t1. The control circuit 9 turns on the switch 52 at the time t2 thereafter, and turns off the battery unit 22 at the time t3 thereafter.

As described above, the switch 53 is turned off before the switch 52 is turned on. Accordingly, the following effects are achieved in contrast to the opposite case. Specifically, if the switch 52 is turned on before the switch 53 is turned off, the switch 52 and 53 are on at the same time. At this time, ground fault current flows from the power storage device 1 to the ground fault F3 or the ground fault F6 via the switches 52 and 53. This ground fault current does not contribute to the operation of the loads 81 to 84. In view of this, by turning off the switch 53 before turning on the switch 52, it is possible to avoid the state where the switches 52 and 53 are on at the same time, thus avoiding such ground fault current.

In the timing chart at the bottom of FIG. 13, in the case where the control pattern C is employed initially, in response to detecting at least either one of the ground faults F3 and F6, the control circuit 9 first turns off the switch 51 at the time t1. The control circuit 9 turns off the switch 53 at the time t2 thereafter, turns on the switch 52 at the time t3 thereafter, and turns off the battery unit 22 at a time t4 thereafter.

Accordingly, it is possible to first cut off the path from the power storage device 1 to the ground fault F3 or the ground fault F6 that includes a smaller resistance path (switch 51). Next, in order to avoid the state where the switches 52 and 53 are on at the same time, the switch 53 is first turned off, and then the switch 52 is turned on. Accordingly, it is possible to supply power to the loads 81 to 83 while also lowering the ground fault current.

Ground Fault F5

When the ground fault F5 occurs on the load 83, power cannot be supplied to the load 83, and therefore the switches 52 and 53 are turned off (see Table 2 as well). Accordingly, the power storage devices 1 and 2 and the power supply line 63 can be cut off from each other. In accordance with the switch pattern for the ground fault F5 in Table 2, in this state, at least either one of the switch 51 and the battery unit 22 is turned on, and therefore power is supplied to the loads 81, 82, and 84 from at least either one of the power storage devices 1 and 2.

For example, if the switch 51 and the battery unit 22 are turned on, power is supplied to the loads 81, 82, and 84 from both of the power storage devices 1 and 2. Also, if the switch 51 is turned off, and the battery unit 22 is turned on, power is supplied to the loads 81 and 82 from only the power storage device 1, and power is supplied to the load 84 from only the power storage device 2. Also, if the switch 51 is turned on, and the battery unit 22 is turned off, the power storage device 1 supplies power to the loads 81, 82, and 84.

When the ground fault F5 occurs, any of the above-described switch patterns may be employed, but the following describes the case where the switch 51 and the battery unit 22 are turned on.

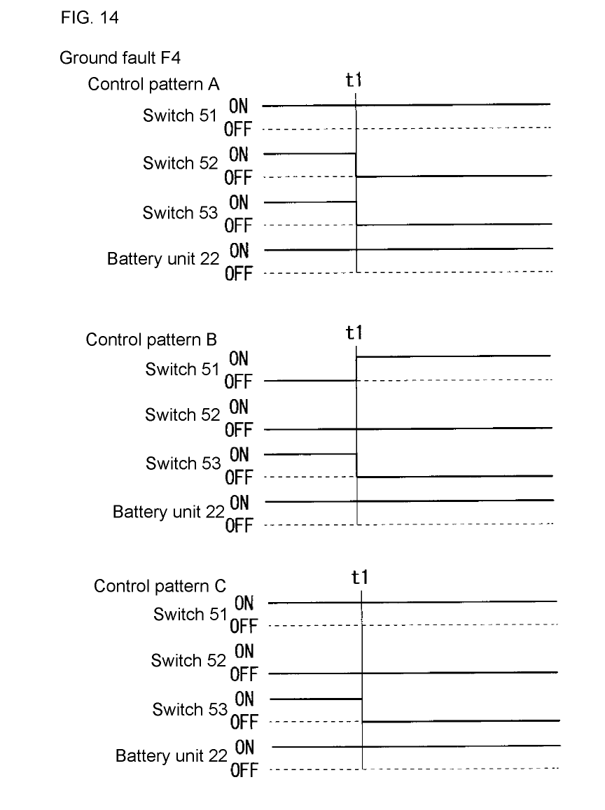

FIG. 14 is a diagram schematically showing an example of timing charts in this case. Three timing charts are shown in the illustration of FIG. 14. In the timing chart at the top of FIG. 14, the control pattern A is employed initially. In response to detection of the ground fault F5, the control circuit 9 turns off the switches 52 and 53 at the time t1.

In the timing chart in the middle of FIG. 14, the control pattern B is employed initially. In response to detection of the ground fault F5, the control circuit 9 turns off the switch 53 and turns on the switch 51 at the time t1.

In the timing chart at the bottom of FIG. 14, the control pattern C is employed initially. In response to detection of the ground fault F5, the control circuit 9 turns off the switch 53 at the time t1.

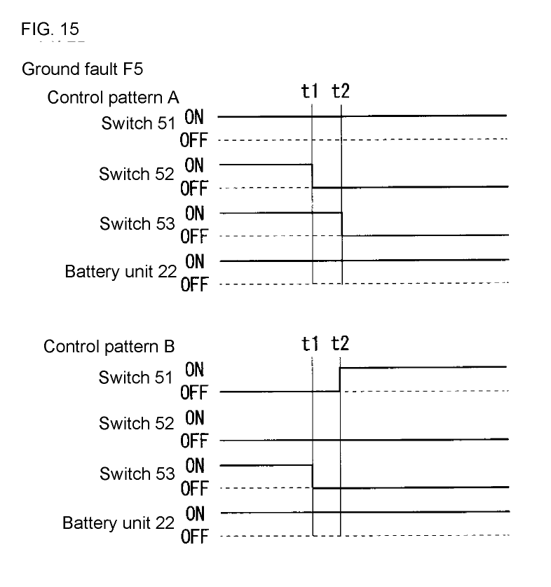

Also, in the illustration of FIG. 14, the control circuit switches multiple switches in the control patterns A and B. In the case where the control circuit 9 cannot switch multiple switches at the same time, control may be performed as described below. FIG. 15 is a diagram schematically showing an example of timing charts in this case. In the timing chart at the top of FIG. 15, the control pattern A is employed initially. The control circuit 9 turns off the switch 52 at the time t1, and then turns off the switch 53 at the time t2. Accordingly, the amount of power stored in the power storage device 1 can be retained more than in the opposite case. In the case where the power storage device 1 is a lead battery, when the vehicle is stopped, dark current flows from the power storage device 1 to the loads 81 and 82. Accordingly, retaining the amount of power stored in the power storage device 1 with priority is suited to retaining dark current.

In the timing chart at the bottom of FIG. 15, the control pattern B is employed initially. The control circuit 9 turns off the switch 53 at the time t1, and then turns on the switch 51. Accordingly, the ground fault current that flows from the power storage devices 1 and 2 to the ground fault F5 can be cut off more quickly than in the opposite case.

Variations

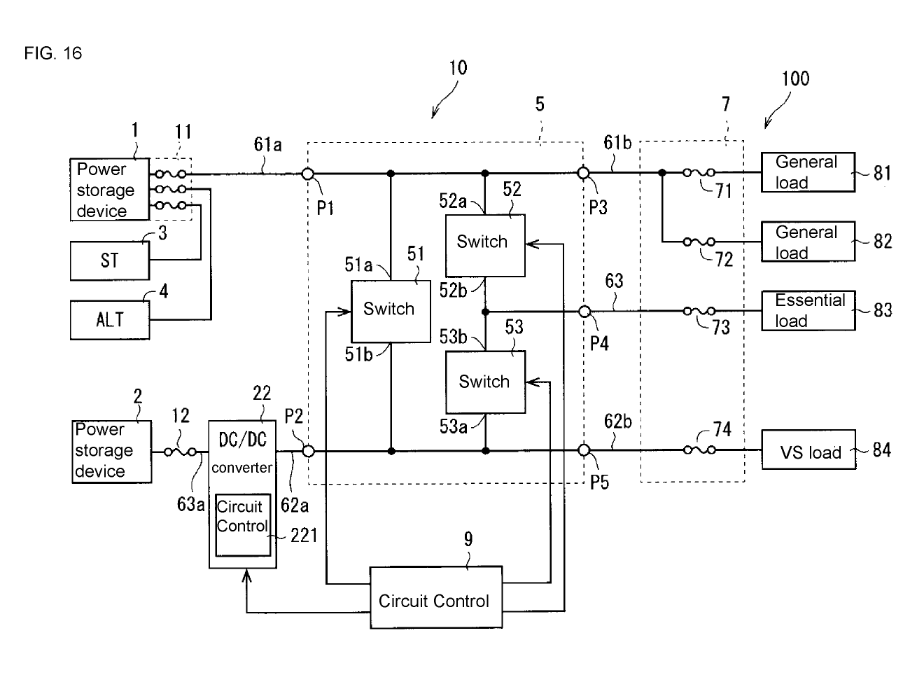

FIG. 16 is a diagram showing an example of a schematic configuration of the in-vehicle power supply system 100. In the illustration of FIG. 16, the battery unit 22 is a bidirectional DC/DC converter and incorporates a control circuit 221. The control circuit 221 receives charge and discharge instructions from the control circuit 9, and causes the DC/DC converter to operate based on the instructions. For example, upon receiving a charge instruction, the control circuit 221 causes the DC/DC converter to convert the voltage on the power supply line 62a to a desired voltage, and outputs the converted voltage to the power storage device 2 via the power supply line 63a. In another example, upon receiving a discharge instruction, the control circuit 221 causes the DC/DC converter to convert the voltage on the power supply line 63a to a desired voltage, and outputs the converted voltage to the power supply line 62a.

Alternatively, the control circuit 221 may receive vehicle information from the control circuit 9 and determine charging or discharging of the power storage device 2 based on the vehicle information. For example, the control circuit 221 may receive, as the vehicle information, information indicating whether or not the generator 4 is generating power. The control circuit 221 may determine that the power storage device 2 is to be charged when the generator 4 is generating power, and determine that the power storage device 2 is to discharge power when power generation by the generator 4 is stopped.

Also, when the current flowing in the DC/DC converter exceeds an upper limit value, the control circuit 221 may control the DC/DC converter such that the current becomes smaller than the upper limit value, or stop the DC/DC converter.

In this way, in the case where the current flowing through the DC/DC converter is restricted by the control circuit 221, the control circuit 9 does not need to cause the battery unit 22 to operate in accordance with the ground fault F2 that occurs on the power supply line 63a. The reason for this is that the current flowing from the power storage device 1 to the ground fault F2 flows through the DC/DC converter of the battery unit 22, and therefore does not increase as much as normal ground fault current.

Note that in the case where the control circuit 221 stops (turns off) the DC/DC converter when the current flowing through the DC/DC converter exceeds the upper limit value, the above-described operations are consequently performed. Also, in this case, the control circuit 221 stops the DC/DC converter without an instruction from the control circuit 9. The stopping of the battery unit 22 can therefore be performed at the same time as the control of the switches 51 to 53. For example, as shown by the timing chart at the top of FIG. 8, when the ground fault F2 occurs, the switch 51 can be turned on and the battery unit 22 can be stopped at the same time. The same follows for the other ground faults as well.

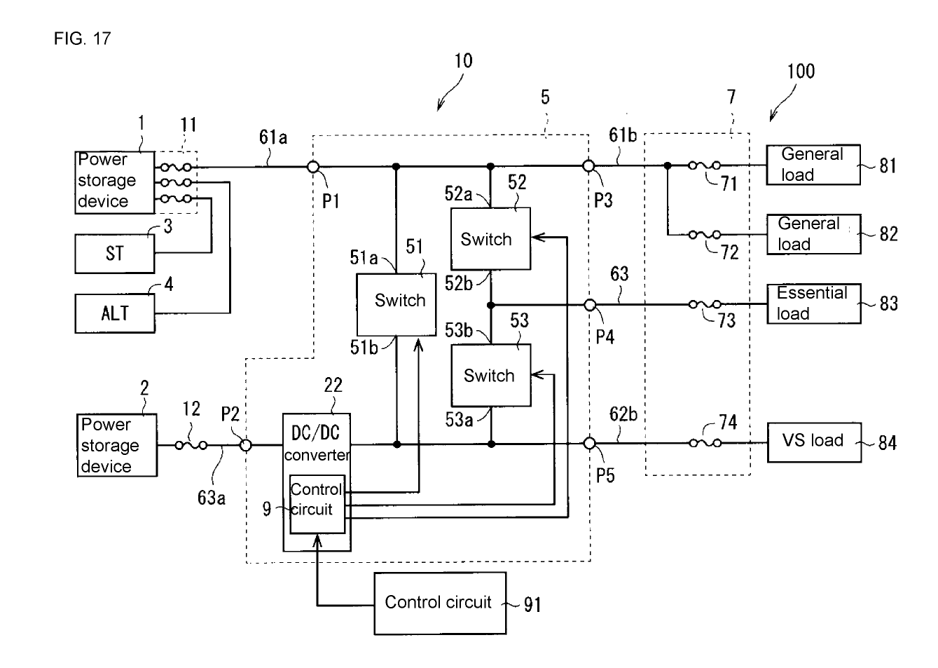

FIG. 17 is a diagram showing another example of the schematic configuration of the in-vehicle power supply system 100. In the illustration of FIG. 17, the battery unit 22 is housed in the switch device 5. For example, a configuration is possible in which the switch device 5 has a package, and the switches 51 to 53 and the battery unit 22 are housed inside the package. Accordingly, the switch device 5 is easy to handle and easily installed in a vehicle. Also, the control circuit 9 may be housed in the battery unit 22. The control circuit 9 receives vehicle information from a higher-ranking control circuit 91. The control circuit 9 selects a control pattern based on this vehicle information.

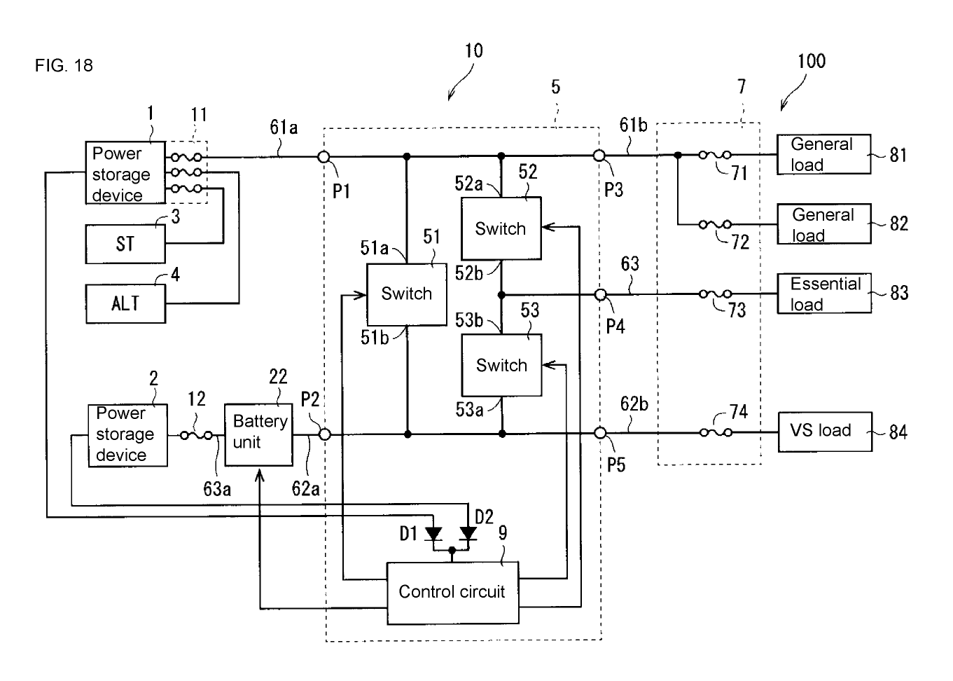

FIG. 18 is a diagram showing another example of the schematic configuration of the in-vehicle power supply system 100. In the illustration of FIG. 18, unlike FIG. 1, the control circuit 9 is housed in the switch device 5. For example, a configuration is possible in which the switch device 5 has a package, and the switches 51 to 53 and the control circuit 9 are housed inside the package. This control circuit 9 may perform communication with a higher-ranking control circuit (e.g., an external ECU), for example. The control circuit 9 controls the switches 51 to 53 and the battery unit 22 based on vehicle information that is transmitted from the higher-ranking control circuit.

Also, in the illustration of FIG. 18, the control circuit 9 receives power from the power storage devices 1 and 2 as operating power. For example, the power storage device 1 is connected to the control circuit 9 via a diode D1. The forward direction of the diode D1 is the direction from the power storage device 1 to the control circuit 9. The power storage device 2 is connected to the control circuit 9 via a diode D2. The forward direction of the diode D2 is the direction from the power storage device 2 to the control circuit 9. Normally, the body of a vehicle is set to a low potential (earth), and therefore here, the cathodes of the diodes D1 and D2 are connected to each other.

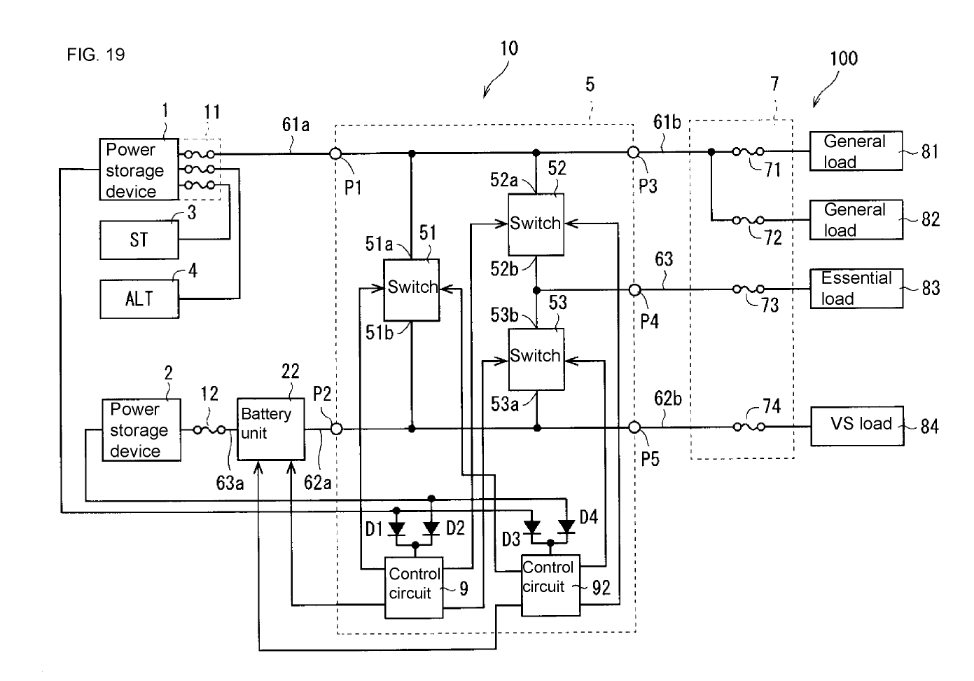

FIG. 19 is a diagram showing another example of the schematic configuration of the in-vehicle power supply system 100. In the illustration of FIG. 19, unlike FIG. 18, a control circuit 92 is further provided. This control circuit 92 may also be housed in the switch device 5. Also, the control circuit 92 receives power from the power storage devices 1 and 2. In the illustration of FIG. 19, the power storage device 1 is connected to the control circuit 92 via the diode D3. The forward direction of the diode D3 is the direction from the power storage device 1 to the control circuit 92. The power storage device 2 is connected to the control circuit 92 via a diode D4. The forward direction of the diode D4 is the direction from the power storage device 2 to the control circuit 92. In the example shown here, the cathodes of the diodes D3 and D4 are connected to each other.

The control circuit 92 can also control the switches 51 to 53 and the battery unit 22. For example, the logical sum of the output of the control circuits 9 and 92 may be used as control signals for the switches 51 to 53 and the battery unit 22. Accordingly, even if either one of the control circuits 9 and 92 malfunctions, the other one can control the switches 51 to 53 and the battery unit 22. In other words, redundancy can be provided for the control circuit.

Alternatively, the logical product of the output of the control circuits 9 and 92 may be used as control signals for the switches 51 to 53 and the battery unit 22. Accordingly, even if runaway occurs in either one of the control circuits 9 and 92, the other one can turn off the switches 51 to 53 and the battery unit 22. In this case, an innovation may be made to provide redundancy for the control circuit. For example, a configuration is possible in which if the control circuit 92 does not respond to an inquiry from the control circuit 9, the control circuit 9 ends the operation of the control circuit 92, and the control circuit 9 controls the switches 51 to 53 and the battery unit 22. The opposite applies as well.

The configurations described in the above embodiments and variations can be appropriately combined as long as no contradiction arises.

Although this description has been described in detail above, the above description is illustrative in all respects, and this description is not limited to the above description. It will be understood that numerous variations not illustrated here can be envisioned without departing from the range of this description. For example, patterns other than the control pattern shown in Table 1 may be employed. Also, consideration may be given to not only ground faults on the power supply lines 61a, 62a, 63a, 61b, 62b, and 63, but also ground faults that occur in the wiring pattern in the switch device 5 and ground faults that occur in the power storage devices 1 and 2.

### LIST OF REFERENCE NUMERALS

1, 2 Power storage device (first power storage device, second power storage device)
5 Switch device
9 Control circuit
10 In-vehicle power supply device
22 Battery unit
51-53 Switch (first to third switches)
81-84 Load

1. (canceled)

2. An in-vehicle power supply switch device comprising:
a first switch that is connected between a first load and a first power storage device;
a second switch that is connected between the first load and a second power storage device; and
a third switch that is connected in parallel to a set of the first switch and the second switch, and has a smaller resistance value than both a resistance value of the first switch and a resistance value of the second switch, and
further comprising a control circuit that controls on and off states of the first switch, the second switch, and the third switch,
wherein upon detecting that a ground fault occurred on a first power storage device side of the first switch or the third switch, the control circuit turns off the third switch before turning off the first switch.

3. An in-vehicle power supply switch device comprising:
a first switch that is connected between a first load and a first power storage device;
a second switch that is connected between the first load and a second power storage device; and
a third switch that is connected in parallel to a set of the first switch and the second switch, and has a smaller resistance value than both a resistance value of the first switch and a resistance value of the second switch, and
further comprising a control circuit that controls on and off states of the first switch, the second switch, and the third switch,
wherein upon detecting that a ground fault occurred on a second power storage device side of the second switch or the third switch, the control circuit turns off the third switch before turning off the second switch.

4. The in-vehicle power supply switch device according to claim 2 wherein the first power storage device is a lead battery, and
upon detecting that a ground fault occurred on a first load side of the first switch, the control circuit turns off the first switch before turning off the second switch.

5. The in-vehicle power supply switch device according to claim 2, wherein one end of the second switch, the one end being on a second power storage device side, is connected to the second power storage device via a switch or a battery unit that is a bidirectional DC/DC converter, and
when the control circuit detects that a ground fault occurred on a second power storage device side of the battery unit in a state where the second switch and the third switch are on or a state where the first switch is on, the battery unit turns off.

6. An in-vehicle power supply device comprising:
the in-vehicle power supply switch device according to claim 2;
and the first power storage device and the second power storage device.

7. The in-vehicle power supply switch device according to claim 3,
wherein the first power storage device is a lead battery, and
upon detecting that a ground fault occurred on a first load side of the first switch, the control circuit turns off the first switch before turning off the second switch.

8. The in-vehicle power supply switch device according to claim 3,
wherein one end of the second switch, the one end being on a second power storage device side, is connected to the second power storage device via a switch or a battery unit that is a bidirectional DC/DC converter, and
when the control circuit detects that a ground fault occurred on a second power storage device side of the battery unit in a state where the second switch and the third switch are on or a state where the first switch is on, the battery unit turns off.

9. The in-vehicle power supply switch device according to claim 4,
wherein one end of the second switch, the one end being on a second power storage device side, is connected to the second power storage device via a switch or a battery unit that is a bidirectional DC/DC converter, and
when the control circuit detects that a ground fault occurred on a second power storage device side of the battery unit in a state where the second switch and the third switch are on or a state where the first switch is on, the battery unit turns off.

10. An in-vehicle power supply device comprising:
the in-vehicle power supply switch device according to claim 3; and the first power storage device and the second power storage device.

11. An in-vehicle power supply device comprising:
the in-vehicle power supply switch device according to claim 4; and the first power storage device and the second power storage device.

12. An in-vehicle power supply device comprising:
the in-vehicle power supply switch device according to claim 5; and the first power storage device and the second power storage device.
